(19) United States
(12) Patent Application Publication
(10) Pub. No.: US 2022/0382923 A1
(43) Pub. Date: Dec. 1, 2022

(54) Converting Arbitrary Geometry, Material, and Boundary Properties of an Object to a Form Usable by a Mesh-Based Solver

(71) Applicant: Intact Solutions, Inc., Madison, WI (US)

(72) Inventors: Sandilya Kambampati, Madison, WI (US); Andrew E. Taber, Madison, WI (US); Goldy Kumar, Madison, WI (US)

(21) Appl. No.: 17/331,992

(22) Filed: May 27, 2021

(51) Int. Cl. G06F 30/10; G06F 17/16

(52) U.S. Cl. CPC G06F 30/10; G06F 17/16; G06F 2111/10

(57) ABSTRACT

Persistent storage may contain a source model of a physical object that defines source geometric properties and source material properties of the physical object, wherein the physical object can be described using an inner product representation. One or more processors may be configured to: select effective geometric properties of an effective model, wherein the effective model is defined using a mesh of elements; determine effective material properties of the effective model such that the effective model defines the effective geometric properties and the effective material properties using the inner product representation; provide, to a solver application, the effective model; receive, from the solver application, an effective solution for the effective model; and generate a source solution to the source model by projecting the effective solution onto the source model, wherein the source solution is expressed as a field or gradients reconstructed based on each of the elements in the mesh.

### BACKGROUND

Finite element analysis (FEA) includes a set of computerized techniques that predict how a physical object will react to real-world forces, vibrations, heat, fluid flows, electrostatics, and so on. Such predictions can help a designer determine where the object might break, wear, or otherwise fail to operate or respond as expected. FEA models the object as a mesh of finite elements (perhaps millions or even billions), such as hexahedral or tetrahedral shapes. The computer uses sets of equations to predict the behavior of each element, and then combines the individual behaviors to predict the overall behavior of the object.

This allows models of the object to be constructed, refined, and optimized before the object is actually manufactured. FEA is used in the fields of engineering and scientific computing (e.g., aerospace and automotive design), and can dramatically improve physical object design by, for example, producing stiffness, strength, temperature, and pressure visualizations, as well as by reducing weight, materials, and costs of the object.

FEA fundamentally requires computers in practice, because its processes are too complex for humans to carry out in the vast majority of real-world applications. FEA software programs are often referred to as FEA solvers. Nonetheless, some objects are so complex that mesh-based FEA solvers either cannot analyze the object with a fine enough mesh, fail due to lack of processing and/or memory capacity of the computing systems on which they execute, or take an unacceptably long amount of time to do so. This means that there are classes of physical objects that do not lend themselves to standard FEA procedures, or at least require a significant investment in computing power in order to be analyzed in a meaningful fashion.

### SUMMARY

The embodiments herein overcome these and possible other drawbacks and limitations by introducing pre-processing and post-processing techniques that can be integrated with an existing FEA solver. The pre-processing techniques can transform an arbitrary definition of a source model (using meshed or non-meshed geometry as well as physical material properties and boundary conditions) into an effective model (which may be a finite element model that encapsulates mesh-based geometry of a form that is required by the FEA solver as well as hypothetical material properties and boundary condition properties such as single point and multi-point constraints). This effective model may be defined in one or more files or by way of programmatic (procedural) interfaces of an FEA solver, and preserves certain underlying characteristics of the source model. The FEA solver may be executed on the effective model to produce a result. The result also may be defined in one or more files, and represents a solution to the analysis as performed on the effective model. The post-processing techniques can map the result into a form that relates to the source model.

Standard meshing can be a complex process, involving discretization of an object into smaller elements, smoothing, removing small features, and so on. If not done properly, meshing can introduce errors. Advantageously, the mesh-based geometry of the effective model that is introduced to the FEA solver can be much simpler than would be the case for standard meshing techniques. Thus, complex meshing procedures can be avoided.

In this manner, accurate solutions to problems related to the source model can be obtained using a simpler model, and less computing resources. Consequently, more complex physical objects with arbitrary source geometries can be successfully analyzed, whereas this may not have been possible in the past or at least would have required significantly more computing power. Thus, the embodiments herein provide efficient ways of understanding the behavior of physical objects prior to their construction.

Accordingly, a first example embodiment may involve persistent storage containing a source model of a physical object, wherein the source model defines source geometric properties and source material properties of the physical object, and wherein the physical object can be described using an inner product representation. One or more processors configured to: select effective geometric properties of an effective model, wherein the effective geometric properties are supported by an FEA solver application, wherein the effective geometric properties are different from the source geometric properties, and wherein the effective model is defined using a mesh of elements; determine effective material properties of the effective model such that the effective model defines the effective geometric properties and the effective material properties using the inner product representation, and wherein the effective material properties are different from the source material properties; provide, to the FEA solver application, the effective model; receive, from the FEA solver application, an effective solution for the effective model; and generate a source solution to the source model by projecting the effective solution onto the source model, wherein the source solution is expressed as a field or gradients reconstructed based on each of the elements in the mesh.

A second example embodiment may involve obtaining, from persistent storage, a source model of a physical object, wherein the source model defines source geometric properties and source material properties of the physical object, and wherein the physical object can be described using an inner product representation. The second example embodiment may also involve selecting effective geometric properties of an effective model, wherein the effective geometric properties are supported by an FEA solver application, wherein the effective geometric properties are different from the source geometric properties, and wherein the effective model is defined using a mesh of elements. The second example embodiment may also involve determining effective material properties of the effective model such that the effective model defines the effective geometric properties and the effective material properties using the inner product representation, and wherein the effective material properties are different from the source material properties. The second example embodiment may also involve providing, to the FEA solver application, the effective model. The second example embodiment may also involve receiving, from the FEA solver application, an effective solution for the effective model. The second example embodiment may also involve generating a source solution to the source model by projecting the effective solution onto the source model, wherein the source solution is expressed as a field or gradients reconstructed based on each of the elements in the mesh.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 provides an illustration of FEA, in accordance with example embodiments.

FIG. 4 depicts an improved FEA pipeline, in accordance with example embodiments.

FIG. 5 depicts transformation of an object to a simplified mesh-based representation, in accordance with example embodiments.

FIG. 6 depicts transformation of geometry and material properties of a source model into those of a functionally equivalent effective model, in accordance with example embodiments.

FIG. 7 depicts representing a source model as an effective model made up of an assemblage of cubes, in accordance with example embodiments.

FIG. 8 depicts representing an element of a source model as a filled-in element of an effective model with hypothetical springs connecting degrees of freedom, in accordance with example embodiments.

FIG. 9 depicts representing a partial cube element of a source model as a full cube element of an effective model, in accordance with example embodiments.

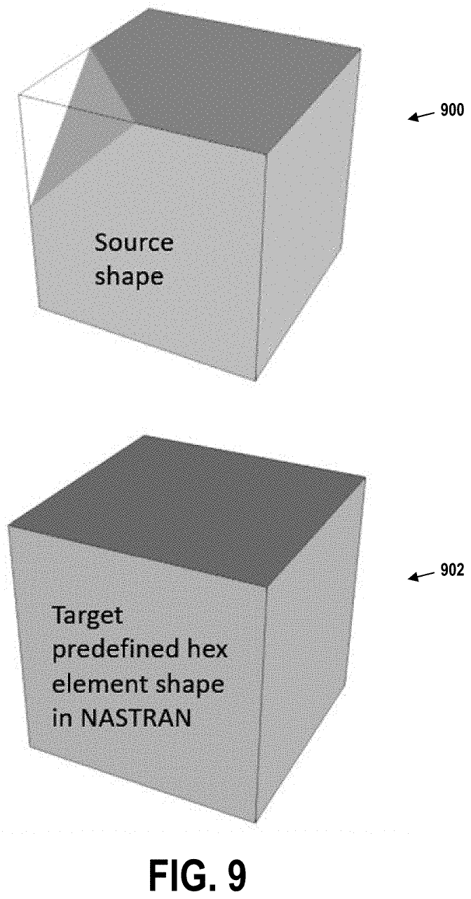

FIG. 10 depicts a mapping between boundary conditions of a source model and multipoint constraints of an effective model, in accordance with example embodiments.

FIG. 11 depicts post-processing of an effective solution provided by an FEA solver to a form consistent with the source model, in accordance with example embodiments.

FIG. 12 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, the mathematical notation used herein may in some cases conform to commonly-used notation and in other cases may be novel. In the expressions provided, one of ordinary skill in the art would understand that some terms or variables may be overloaded for convenience, or used to refer to different properties in different equations. Thus, these terms and variables should be considered within the context of how they are used, with the understanding that they may or may not be used in a fashion that is familiar to the reader.

### I. Example Computing Devices and Cloud-Based Computing Environments

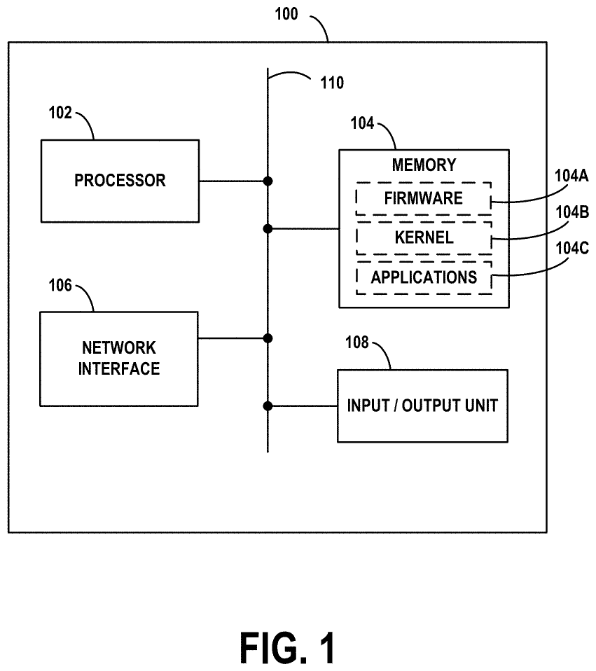

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling, and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support a computing architecture. The exact physical location, connectivity, and configuration of these computing devices may be unknown and/or unimportant to client devices. Accordingly, the computing devices may be referred to as “cloud-based” devices that may be housed at various remote data center locations.

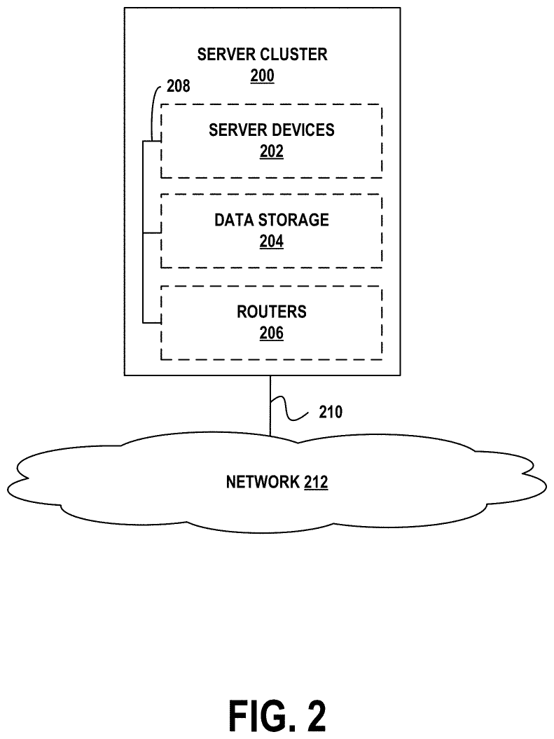

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### II. Example of FEA

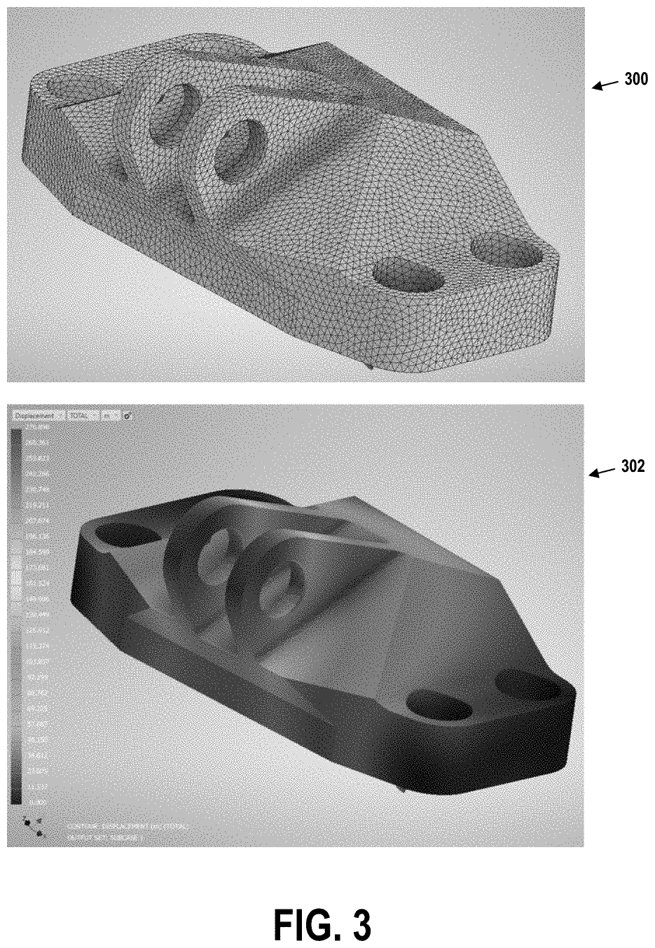

In order to illustrate the improvements provided by the embodiments herein, a simple example of FEA is provided with reference to FIG. 3. In many useful applications, however, FEA can be much more complicated and different techniques can be used. Further, FIG. 3 depicts a three-dimensional object, but FEA techniques can be used on two-dimensional objects as well. Thus, this discussion is for purposes of example.

In FEA, an object, such as the three-dimensional solid of image 300, is modeled as being subdivided into an assembly of small parts called elements (finite elements). The elements are assumed to be connected to one another, but only at particular points, known as nodes. In most cases, these elements are small regions, not separate entities like blocks, and there are no cracks or surfaces between them. There is a limited, or finite, number of degrees of freedom used to model the behavior of each element. The complete set of elements is known as a mesh. The example of image 300 shows its object subdivided into a mesh of elements with nodes represented as points. The process of representing a component as an assemblage of finite elements, known as discretization, meshing, or gridding.

A field variable, such as stress or temperature, can be described throughout the object by a set of partial differential equations that are impossible to solve analytically for arbitrary geometries and materials. To overcome this problem, it is assumed that the field variable acts through or over each element in a predefined manner, such as in accordance with a constant, a linear function, a quadratic function, or a higher order function. The number and type of elements chosen should be such that the field variable distribution through the object is adequately approximated by the combined elemental representations. If the mesh is too coarse, the resolution of the parametric distribution may be inadequate, whereas too fine a mesh is wasteful of computing resources and might not even be solvable.

After model discretization, the governing equations for each element are calculated and then assembled into a system of equations for the object. Once the general format of the equations of an element type (e.g. a linear distribution element) is derived, the calculation of the equations for each occurrence of that element can take place. Node coordinates, material properties, and loading conditions of the element are substituted into the general format. The individual element equations are assembled into the system equations, which are solved to describe the behavior of the object as a whole.

This behavior can be visually represented, such as in image 302 with grayscale coloring for different displacement values. With this information, a designer can easily determine the any potential weak section in the design, such as where the object might break under applied stress. The designer may then attempt to rectify the situation by improving the design, such as by thickening weak sections or by using a stronger material for these sections.

To provide further detail, consider a static analysis of the object depicted in image 300. Let [k] be a square matrix of values representing stiffness associated with each node, S be a vector of unknown nodal displacements, and ƒ be a vector of forces applied to the nodes. The load-displacement relationships of for the nodes is then given by [k]δ=ƒ. This equation can be expressed as δ=[k]⁻¹ ƒ to solve for the displacements (e.g., as shown in image 302), but doing so requires boundary conditions (e.g., loads, fixed nodes, known displacements, and/or other constraints) to be defined.

The result is a system of equations that can be in the millions or billions, and thus non-trivial to solve. In particular, the matrix [k] may be computationally prohibitive or impossible to invert directly, though simplifying techniques can be used to group terms around the diagonal of the matrix and zero out more distant terms. In any event, the discretizing step and the applying of the boundary conditions to relevant elements can be very time consuming, in some cases takes over 70% of the total computational time and effort.

### III. Moment-Based Representations of Geometries and Materials

The properties of objects with certain geometries and made of certain materials can be represented as moments. The geometric representation of an object, such as a description of the object's shape, can be quantified using one or more moment-vectors that may then be used to compute integrals of arbitrary functions over the object's volume in a manner that is independent of the formalism used to describe the object. In analytical terms, an object's shape or volume may be specified mathematically as a domain. Thus, integration is carried out over a domain for the object. In an example embodiment, a domain may be discretized into a set of elements (also sometimes referred as cells in this context), and a moment-vector may be computed for each element. The use of moment-vectors of geometry may be extended to encompass representations of material fields defined over the geometry.

A. Moments of a Geometry

Let Ω be a bounded subset of [symbol] (three-dimensional real vector space) whose indicator function is Riemann-integrable. Note that this definition generalizes the typical solid modeling formulation if regularity of the domain is not assumed, as integrals are not affected by sets of measure zero, and any lower-dimensional manifold has measure zero. A moment is a quantitative measure of the shape of a set of points Ω2. In one dimension, the ith moment is given as:

mᵢ=∫_{Ω}xⁱρdΩ,i∈{0,1,2, . . . }, (1)

This can be generalized to three dimensions (x, y, and z) for arbitrary shape Ω as:

M_{i,j,k}=∫_{Ω}xⁱy^{j}z^{k}ρdΩ,i,j,k∈{0,1,2, . . . }. (2)

If ρ represents mass density, then moments are interpreted as classical physical quantities like total mass, center of mass, and rotational inertia. If ρ is the probability density, then moments may be interpreted as total probability, mean, variance and so on. The moment definition can also be generalized from monomials xⁱy^{j}z^{k} to other polynomial bases. From an algebraic point of view, moments are projections (with respect to L² inner product) of ρ onto a polynomial basis. Herein, moments will be considered with respect to a monomial basis with ρ=1 and the “moment-vector” of order n will be taken to consist of the following moments over the domain Ω:

M=[M_{0,0,0},M_{1,0,0}, . . . ,M_{n,0,0},M_{n,1,0}, . . . ,M_{n,n,0},M_{n,n,1}, . . . ,M_{n,n,n}]^{T}. (3)

Quadrature rules are numerical integration techniques used to approximate the integrals of arbitrary functions. A quadrature rule may be given as:

∫_{Ω}ƒdΩ≈Σᵢ₌₀ⁿwᵢƒ(xᵢ). (4)

A quadrature rule is defined by a set of sample points and their corresponding weights, which are denoted herein as X={x₀, x₁, . . . , xₙ} and W={w₀, w₁, . . . , wₙ}, respectively. Quadrature rules are generally provided for a normalized geometry and can be obtained for affine transformations of the normalized geometry.

If the moment-vector M is known for a shape, a technique called “moment-fitting” can be used to obtain quadrature rules to approximately integrate arbitrary functions over that shape. Assuming the arbitrary integrand ƒ can be approximated by a basis {ƒᵢ|i∈1 . . . n} as:

ƒ≈Σᵢ₌₁ⁿcᵢƒᵢ, (5)

Then:

∫_{Ω}ƒdΩ≈∫_{Ω}Σᵢ₌₁ⁿcᵢƒᵢdΩ=Σᵢ₌₁ⁿcᵢ∫_{Ω}ƒᵢdΩ. (6)

In accordance with example embodiments, it may be observed out that the coefficients cᵢ need not be known a priori, as minimizing the integration error of each ƒᵢ will in turn minimize the integration error of ƒ by linearity. This leads to a system of equations as follows:

$$A \cdot W = M \\ A = [ \begin{matrix}{f}_{1} ( {x}_{1} ) & {f}_{1} ( {x}_{2} ) & … & {f}_{1} ( {x}_{q} ) \\ {f}_{2} ( {x}_{1} ) & {f}_{2} ( {x}_{2} ) & … & {f}_{2} ( {x}_{q} ) \\ ⋮ & ⋮ & ⋱ & ⋮ \\ {f}_{n} ( {x}_{1} ) & {f}_{n} ( {x}_{2} ) & … & {f}_{n} ( {x}_{q} )\end{matrix} ] , \\ W = [ \begin{matrix}{w}_{1} \\ {w}_{2} \\ ⋮ \\ {w}_{q}\end{matrix} ] , \\ M = [ \begin{matrix}{m}_{1} \\ {m}_{2} \\ ⋮ \\ {m}_{q}\end{matrix} ] , \\ with {m}_{i} = {\int }_{Ω} {f}_{i} d Ω . \qquad ( 7 )$$

In Equation (7), {x₁, x₂, . . . x_{q}}=X are the quadrature points, ƒ₁, ƒ₂, . . . , ƒₙ is the polynomial basis (often a monomial basis), A is the matrix of samples of the basis functions at the quadrature points, W is the weight vector, and M is the moment-vector. In principle, given the moment-vector M, optimal points X and weights W can be generated via non-linear optimization. In practice, however, the points X are prescribed, as this results in a linear system of equations. To avoid underdetermined systems, q=n may be chosen, and a QR decomposition may be used to solve the least-squares problem.

Standard quadrature rules like the Gaussian and Lobatto rules can be recovered via moment-fitting. Thus, moment-fitting generalizes standard quadrature rules to arbitrary domains and bases.

B. Moment-Vector Analysis Framework

In the finite element method, the governing physical equations are expressed in their weak forms, which are integral equations. Evaluation of integral quantities may therefore be considered of primary importance in the finite element method, regardless of the particular physical phenomenon being simulated.

Assume that there are two quadrature rules with points X₁ and X₂ and weights W₁ and W₂, respectively, such that:

A₁·W₁=A₂·W₂=M, (8)

Where M is a moment-vector of order n. It follows that an equivalence class of quadrature rules may be defined using Equation (8), where two rules (defined by the pair A and W) are equivalent if their product A·W is the same moment-vector. Therefore M is the more fundamental quantity, since it uniquely determines an equivalence class of quadrature rules that exactly integrate a given set of functions.

Quadrature rules can be generated by prescribing a certain number of points and solving Equation (7). The choice of quadrature points affects the stability of the system of equations and produces different weights, but the right hand side summarizes the fundamental integral properties of the domain.

Drawing on the above insights, an analysis system can perform volume integration using quadrature rules generated on-demand from moment-vectors. In accordance with example embodiments, the system may be implemented using a mesh-free finite element method on a regular grid. In further accordance with example embodiments, the system also accommodates straightforward extension to other finite element methods as well.

During analysis, the geometry may be reduced to some physical property matrix such as stiffness matrix K, which is further an assembly of element stiffness matrices. The element stiffness, written Kₑ, may be given as an integral:

Kₑ=∫_{Ω}_{ₑ}FₑdΩₑ (9)

Where Fₑ is a function of the finite element basis function and constitutive properties, and Ωₑ is the intersection of the domain with a local element. If the function F can be reasonably approximated by some polynomial of order n, a quadrature rule that integrates polynomials up to order n is all that is needed. Such a quadrature rule can be generated on demand using the nth order moment-vector Mₑ of Ωₑ, after which it is only necessary that Ωₑ can integrate the basis functions over the element.

Integrals may be formulated on various Boolean expressions of two domains A and B as follows:

∫_{A∪B}ƒdV=∫_{A}ƒdV+∫_{B}ƒdV−∫_{A∩B}ƒdV (10)

∫_{A-B}ƒdV=∫_{A}ƒdV−∫_{A∩B}ƒdV. (11)

Since moment-vectors are vectors of integrals, they inherit these relations by linearity. Denoting the moment-vector of order n on domain Ω as M(Ω), the relations may then be expressed as follows:

M(A∪B)=M(A)+M(B)−M(A∩B) (12)

M(A−B)=M(A)−M(A∩B). (13)

In particular, if A and B are disjoint as point-sets, then the moment-vector of their union is M(A)+M(B). If B⊆A then the moment-vector of their difference is M(A)−M(B). This has implications in the computational properties discussed next.

In terms of moment order n, the worst-case space required to store a moment-vector for an element is O((n+1)³), since a vector of length (n+1)³ must be stored. This implies that the space usage of moment-vectors is constant for a given downstream integrand order, regardless of model complexity. The number of quadrature points scales similarly due to the moment-fitting equations. In contrast, the number and accuracy of quadrature points used in geometrically adaptive integration is a function of the local geometric complexity and depends strongly on heuristic parameters such as maximum subdivision level.

As discussed above, moment-vectors obey simple laws for composition, so any positive (or negative) change Δ to the domain Ω can be taken into account by adding (or subtracting) the moment-vectors M(Δ) and M(Ω). Furthermore, the locality of the moment-vectors implies that only the elements which overlap the change Δ need to be modified, allowing incremental update of moments in the course of a design process.

In accordance with example embodiments, the cost of computing a moment-vector is incurred just once for a given domain and analysis resolution, and the moments can be reused for any set of boundary conditions or physical phenomena. The cost can be further offset by parallelizing the moment-vector computation, since each element's moment-vector depends only on local properties.

In accordance with example embodiments, the location of quadrature points may be prescribed during moment-fitting by using the Gauss-Legendre (GL) distribution for the bounding box of the geometry. Prescribing the quadrature points can ensure that the system of equations exemplified in Equations (5)-(7) is linear, while GL distribution can ensure a well-conditioned linear system. The quadrature rule obtained using moments of order n will exactly integrate any polynomial of order n or less. Some of the points may be located outside the geometry for such a distribution, but it is not a problem as long as the integrand is defined at the points. Again, several choices of basis for moment computation may be available, with monomials usually being the most straightforward. The monomial basis, however, may suffer from ill-conditioned A matrices in Equation (7) due to the large difference in L² norm of the basis functions. Other choices for basis are Legendre polynomials and Chebyshev polynomials. By way of example, monomials are used herein, and good conditioning is ensured by scaling with a change of variables.

The advantageous approach devised in accordance with example embodiments may be illustrated with linear stress analysis. Nonetheless, the moments can be used for other physics as well. The relevant implementation details for this illustration are as follows:
1. For each element, moment-vectors are computed with representation-specific procedures (see further details described below).
2. For each element, the moment-fitting equation is solved to generate a quadrature rule.
3. Using the generated quadrature rule, the stiffness integrand can be accurately integrated for that element.
4. The local stiffness is assembled into the global stiffness matrix.
5. The system of algebraic equations formed by the assembly process is solved.
6. The displacement and stress fields are sampled, producing a visualization of the results.

C. Determining Moments for Different Representations

The divergence theorem is widely used for computing moments of boundary representations as it produces accurate results for symbolically-integrable integrands. A volume integral may be converted to surface integration as follows:

∫_{Ω}_{ₑ} div(F)dΩₑ=∫_{Ω}_{ₑ}F·ndδₑ, (14)

Where F is some vector-valued function, δₑ is the boundary of the local element geometry Ωₑ, and n is the boundary normal. For the current example case, div(F)=xⁱy^{j}z^{k} is the monomial moment, so a suitable F can be readily constructed. Further, for meshes, the divergence theorem can be applied recursively to convert boundary integration to edge integration and so on.

The current example implementation can first trim the full mesh Ω to the element and then extracts edges which lie on the element faces. In accordance with example embodiments, surface integration may be performed on the trimmed mesh and line integration may be performed on the extracted edges. Note that, as a symbolic method, the divergence theorem does not involve geometric approximation of the domain, and any errors in the integration will tend to come from: 1) precision issues in intersection of the domain with the cell; and 2) surface and line integration.

Lower dimensional representations can be of two types: curves with cross-sections (one-dimensional (1D) representations) and surfaces with thicknesses (two-dimensional (2D) representations), which when swept will result in three-dimensional shapes. The moments can be generated by integrating over the lines or surfaces and then weighting the result by the cross-sectional area or thickness for 1D and 2D representations, respectively. Formally, the local element geometry for the current example is simply a set of pairs, that is, Ωₑ={(Cⱼ, Aⱼ)} with j=1, . . . , t, where Cⱼ is a curve or surface and Aⱼ is the corresponding cross-sectional area or thickness. For such an Ωₑ, the moments mᵢ from Equation (7) can be computed as:

mᵢ=∫_{Ω}_{ₑ}ƒᵢdΩₑ=Σⱼ₌₁^{t}∫_{C}_{ⱼ}ƒᵢAⱼdsⱼ,

=Σⱼ₌₁^{t}Aⱼ∫_{C}_{ⱼ}ƒᵢdsⱼ(if Aⱼ is constant) (15)

Where ∫_{c}_{ⱼ} is a line or surface integral. It may be reasonably assumed that the cross-section or the thickness is considerably smaller than the length-scale of the geometry. Moments for one-dimensional reinforcements, lattice structures, G-code, etc. representations and two-dimensional surface representations for slices, stacks, and composite plies can be computed using Equation (15).

Constructive solid geometry models consist of primitives, which are combined with Boolean operations such as union, difference, and intersection. In the case of disjoint point sets, the moments of the primitives can be easily combined via the relations in Equations (12) and (13). In the case of nontrivial intersection, it is possible to leverage the intersection capability present in every CSG system to evaluate the moments.

In unit cell models, a domain consists of copies of repeated unit cells. The unit cell is typically transformed through scaling and rotation as they are tiled (translated) through space. For efficient moment computation, it is advantageous to use the fact that such a domain simply consists of a set of cells that are transformations of a unit cell, that is Ωₑ={Uₜ} with j=1, . . . , t, where Uⱼ=Γⱼ(U) is the unit cell after Γⱼ transformation is applied to U. Since transformation of integrals when a domain is transformed (e.g., rotated and translated) is not straightforward, it is not necessarily easy to transform the moments to get moments of a transformed cell. On the other hand, quadrature rules can be transformed easily under affine transformations. A hybrid approach may be used to obtain moment-vectors for unit cell representations, as explained below.

The quadrature rule for the unit cell may first be computed using the Gaussian rule, if known. Otherwise moment fitting may be used to obtain the point vector X and weight vector W (both of size q). This “unit” quadrature rule may then be composed with the tiling transformations Γⱼs to get the transformed quadrature vector X^{j} and weight vector W^{j}. The moments can be computed using the transformed rule as follows:

mᵢ=∫_{Ω}_{ₑ}ƒᵢdΩₑ=Σⱼ₌₁^{t}∫_{U}_{ⱼ}ƒᵢdUⱼ=Σⱼ₌₁^{t}Σₖ₌₁^{q}ƒ(xₖ^{j})wₖ^{j}, (16)

Where xₖ^{j} and wₖ^{j} are elements of transformed vectors X^{j} and W^{j}, respectively. Note that, in practice, some of the unit cells may not be fully inside an element e. For such a cell Uⱼ, the moment computation in Equation (16) can be approximated by merely discarding the integration points xₖ^{j} (and the associated weights) which are outside the element e, which is reasonable since unit cells are usually considerably smaller than the geometry.

For voxel models, the moments are computed by integrating over the voxels. The computation becomes easy if the voxels are considerably smaller than the overall length-scale of the geometry, as the moment integrand can be assumed constant within the voxels. It may be assumed that the finite element cells align with voxel boundaries, such that local element geometry is simply a set of voxels Vₜ, that is, Ωₑ=Vₜ with j=1, . . . , t. The moments can be computed as:

mᵢ=∫_{Ω}_{ₑ}ƒᵢdΩₑ=Σⱼ₌₁^{t}∫_{V}_{ⱼ}ƒᵢdVⱼ=Σⱼ₌₁^{t}vⱼƒᵢ(pⱼ), (17)

Where vⱼ is the volume of Vⱼ and pⱼ is centroid of Vⱼ. This method of moment computation can be used for traditional voxels (uniform size), adaptive voxels (e.g., available open-source data structure and toolkit for high-resolutions volumes, such as OpenVDB), stacks of images (e.g., CT scans), and so on.

D. Extension to Material Fields

The description above of moment-vectors of geometry may be extended to encompass representations of fields defined over the geometry. As already used herein, at least implicitly, a field, F, may be considered a representation of quantities that vary in space. Expressed analytically, F(r)=F(x,y,z), where F can be scalar, vector, or tensor valued. Fields may be used in the representation of design and manufacturing data during analysis.

A field of quantities that describe the behavior of material of an object for a given physics may be referred to as a “material field.” Material fields may be scalar-valued fields (e.g., density, and isotropic thermal conductivity), or tensor-valued (e.g., structural stiffness, or anisotropic thermal expansion coefficients).

Recall that, with the generalized three-dimensional moment defined in Equation (2) and ρ=1, the moment-vector of order n over the domain Ω could be represented by the expression in Equation (3). As noted, ρ can represent a mass density (which may be heterogeneous) or a probability density, for example. However, the simplifying assumption of ρ=1 is not necessarily required, and need not necessarily hold. In particular, when ρ is not identically one, the moments may encode the spatial distribution of the function p throughout the domain Ω.

In general, any spatially-variable tensor field may be encoded in moments. Consider, for example, a tensor field T(r) having components:

Tₗ^{m},l∈{0,1, . . . ,p},m∈{0,1, . . . ,q} (18)

For each component of the tensor field, the moments of the (scalar) component may be defined as:

M_{i,j,k}(Tₗ^{m})=∫_{Ω}xⁱy^{j}z^{k}Tₗ^{m}dΩ,i,j,k∈{0,1,2, . . . } (19)

These moments encode the spatial distribution of each component of the tensor field T(r). With this formalism, the moment-vector for each tensor component Tₗ^{m} may be expressed as:

M(Tₗ^{m})=[M_{0,0,0}(Tₗ^{m}),M_{1,0,0}(Tₗ^{m}), . . . ,M_{n,0,0}(Tₗ^{m}),M_{n,1,0}(Tₗ^{m}) . . . ,M_{n,n,0}(Tₗ^{m}),M_{n,n,1}(Tₗ^{m}), . . . ,M_{n,n,n}(Tₗ^{m})]^{T} (20)

Once the moments M_{i,j,k}(Tₗ^{m}) of a material field are computed for all i, j, k, l, and m, they can then be used to generate quadrature rules by moment-fitting the moment vector M(Tₗ^{m}) of each component of T(r). This leads to a set of quadrature weights:

wₗ^{m},l∈{0,1, . . . ,p},m∈{0,1, . . . ,q} (21)

The weights can then be assembled into a tensor-valued quadrature weight W, having components wₗ^{m}. With this formalism, the tensor-valued quadrature weights (one for each quadrature point) may be used to assemble integrals of the form:

l_{Ω}ƒ(r)T(r)dΩ≈Σᵢ₌₀^{p}ƒ(rᵢ)W(rᵢ). (22)

As is evident, this form represents a function ƒ(r) multiplied by a material field T(r) computed over a geometric domain Ω. As with the discussion of vector-moments above, the formalism can provide a basis for computation of the integral.

Examples of integrals of this form include stiffness matrices in the finite element method (where the material tensor T is of a size 6×6), mass computations (where the material tensor T is of order one and is thus scalar, and integrals of von Mises stress (such as for computing average von Mises stress).

### IV. Improvements to FEA Procedures

Given its complexity, FEA requires use of computers, because its processes are too complicated for humans to carry out in the vast majority of practical applications. And even with this computer-implementation, some objects are so complex that mesh-based FEA solvers either cannot analyze the object with a fine enough mesh, fail due to lack of processing and/or memory capacity of the computing systems on which they execute, or take an unacceptably long amount of time to do so. This means that there are classes of physical objects that do not lend themselves to standard FEA procedures, or at least require a significant investment in computing power in order to be analyzed in a meaningful fashion. Thus, techniques that can reduce the amount of processing required for FEA are very desirable.

As noted above, the embodiments herein introduce pre-processing and post-processing techniques that can be integrated with an existing FEA solver (e.g., NASTRAN, Calculix, MFEM, Quickfield, Abaqus, etc.). The pre-processing techniques can transform a definition of an arbitrary source geometry (mesh or non-mesh) into a mesh-based geometry of a form that is supported by the FEA solver. The FEA solver may be executed on the effective model to produce a result. The post-processing techniques can map the result into a form that relates to the source geometry. Advantageously, the mesh-based geometry introduced to the FEA solver can be much simpler than would be the case for standard meshing technique.

In this manner, accurate solutions to problems related to the source geometry can be obtained using a simpler model, and less computing resources. Consequently, more complex physical objects with arbitrary source geometries can be successfully analyzed, whereas this may not have been possible in the past or at least would have required significantly more computing power. Therefore, the embodiments herein provide efficient ways of understanding the behavior of physical objects prior to their construction.

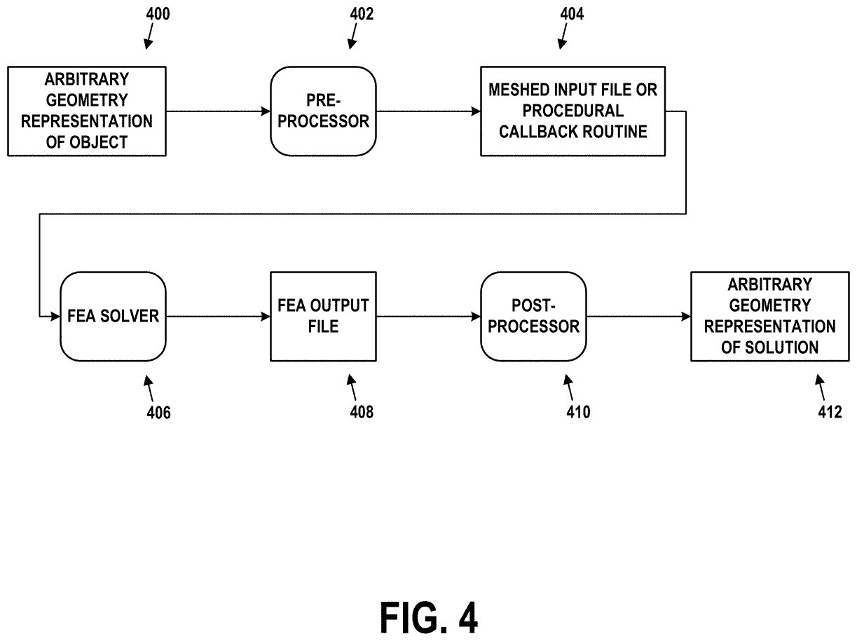

FIG. 4 depict an improved FEA pipeline with new pre-processing and post-processing steps. In FIG. 4, each item with square corners represents data or a state, and each item with rounded corners represents a process (e.g., a software program).

Arbitrary geometry representation 400 is part of a source model of an object. The arbitrary geometry might be meshed or mesh-free. It is assumed that arbitrary geometry representation 400 also includes specification of the material properties and boundary conditions (e.g., loads, constraints, other properties) of the object.

Pre-processor 402 is implemented as a software program, function, or set of routines. Pre-processor 402 can take the arbitrary geometry representation of the object and produce a mesh representation of the object that preserves certain properties of the object. For example, pre-processor 402 may allow the user to choose FEA mesh properties such as an element type (hexahedral/tetrahedral, etc.), resolution (number of elements and adaptivity), basis function types and orders, and so on.

As will be discussed below, these preserved properties include inner products. Due to features of pre-processor 402, the mesh representation that it produces may be much simpler than conventional meshes for the same object (e.g., the processing required the FEA solver is reduced). In the case that block 400 is mesh-based, the mesh produced may have fewer elements, fewer boundary conditions, and/or simpler boundary conditions.

Meshed input file or procedural callback routine 404 is generated by executing pre-processor 402 on arbitrary geometry representation 400. Meshed input file or procedural callback routine 404 defines or facilitates the definition of a mesh representation of the object, as well as relevant boundary conditions, that are compatible with FEA solver 406. For example, meshed input file or procedural callback routine 404 may include definitions of material data, elements, coordinates of nodes, the equations (functions) to apply to the elements, and the boundary conditions. In some cases, meshed input file or procedural callback routine 404 may in fact be one or more files or routines.

Instead of an input file, pre-processor 402 may generate a procedural callback routine (i.e., programmatic code for an algorithm that may be invoked at-will) that the FEA solver can use to query for the FEA properties instead of querying from an input file. This saves computation time when the input file would be large and the reading thereof would be time consuming.

FEA solver 406 is also implemented as a software program, function, or set of routines. FEA solver 406 can be any free, commercial, off-the-shelf, or other form of software that solves FEA problems. For purposes of this discussion, FEA solver 406 may be viewed a black box that takes meshed input as input and produces FEA output file 408 as output.

FEA output file 408 may contain a representation of a solution provided by FEA solver 406, for example. This solution might include a vector of nodal displacements, each entry in the vector representing the displacement of one of the nodes in the discretized object. In some cases, meshed FEA output file 408 may in fact be one or more files.

Post-processor 410 is also implemented as a software program, function, or set of routines. As described in more detail below, post-processor 410 can take the solution from FEA output file 408 and project the solution back onto the source model of arbitrary geometry representation 400. Like the operations of pre-processor 402, this projection may preserve certain properties of the solution, such as inner products.

Arbitrary geometry representation 412 is the projected solution generated by executing post-processor 410 on FEA output file 408. In other words, arbitrary geometry representation 412 is a solution to the source model defined by arbitrary geometry representation 400.

The functionality depicted in FIG. 4 can be distributed in various ways. As noted, pre-processor 402, FEA solver 406, and post-processor 410 may be individual and distinct software programs. In some cases, the functionality of pre-processor 402 and post-processor 410 could be combined into one software program. Further, it is possible that FEA solver 406 may execute on a different computing system that pre-processor 402 and post-processor 410. Other possibilities exist.

A. Pre-Processing

As a brief overview, the pre-processing described herein is different from standard FEA pre-processing, which would involve the time-intensive tasks of discretization of an object into smaller elements, smoothing, removing small features, and so on. These standard FEA steps may require up to 70% of the overall time used to produce a result (e.g., a displacement vector) for any given object.

Instead, the pre-processing embodiments herein allow a non-mesh specification of an object's geometry, material, and boundary conditions (a source model) to be transformed to a functionally equivalent unfitted mesh of space (an effective model). In alternative embodiments, the source model may be defined using a mesh or a partial mesh, and the effective model is a meshed specification that is simpler to solve (relatively speaking) than when conventional meshing techniques are applied to the source model. This effective model can be provided to an FEA solver, which can then provide results for the effective model. The post-processing steps described below then transform the results for the effective model back to a functionally equivalent set of results for the source model.

Herein, the term “functionally equivalent” may be interpreted to mean that the source model and the effective model have certain properties that are equivalent to one another, or at least preserved as the source model is transformed into the effective model. Likewise, the results for the source model and the effective model are functionally equivalent when the results for the source model represent a solution to a problem associated with the source model within a reasonable degree of accuracy when compared to a solution provided by standard FEA.

Notably, the effective model may represent geometry, material, and/or boundary conditions that do not exist in the physical world, cannot exist in the physical world, or at least have not yet been discovered. Nonetheless, the FEA solver may be able to operate on an effective model and provide associated results. Thus, the embodiments herein do not require modification of standard FEA code. More specifically, the transformation of the source model into the effective model may involve changing at least some of the object's geometry, material, and boundary conditions to form a simpler mesh representation than would be required for FEA to be performed on the source model.

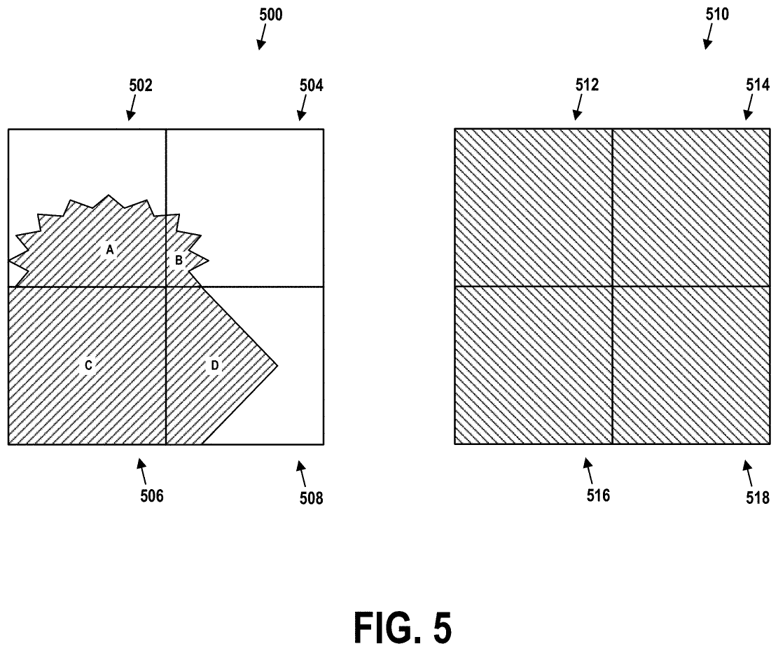

FIG. 5 provides an example, simplified for purposes of illustration. Source model 500 consists of a mesh of four elements (502, 504, 506, and 508) each representing part of a geometry of an object. The area of the object is represented by the shaded portions of each element, A, B, C, and D. Given the material of the object (e.g., a type of metal) and its boundary conditional, an FEA solver can calculate a result for the source model (e.g., a displacement vector) by performing integrations over the spaces representing the shape of object in each element. In other words, the integrations in element 502 may be with respect to the line that divides portion A from the empty (blank) space in this element. Note that this line may define a shape that contains discontinuities that would potentially require multiple integrations. In full generality, the shape in any element can be made by an arbitrary curve and/or represented by a set of equations. Clearly, the integration for element 506 is almost certainly much simpler than the integrations for elements 502, 504, and 508 because the object fills all of element 506.

The embodiments herein differ from the conventional approach because they involve considering each element in its entirety, but with different material properties and boundary conditions. These material properties and boundary conditions are selected so that the effective model is functionally equivalent to the source model, but requires much less processing from an FEA solver.

To that point, effective model 510 consists of a mesh of four elements (512, 514, 516, and 518) each representing part of a geometry of a different object. As indicated by the shading, all four of these elements are full, which simplifies FEA processing. But the different shading used in source model 500 and effective model 510 indicates that a different material (e.g., a hypothetical material that may not actually exist) and different boundary conditions are being used in effective model 510. Thus, the change in geometry to simplify FEA processing is accompanied by changes to the material and boundary condition so that the effective model is functionally equivalent to the source model. In other words, certain geometric properties have been traded for material properties.

More generally, the embodiments herein provide techniques for modifying the solution process of the underlying differential equations that govern the behavior of geometry and material of an object. The object can be two-dimensional, three-dimensional, or even of higher dimensions. The modification is done in such a fashion that the result for the effective model that is produced by the FEA solver can be transformed into an accurate result for the source model.

Doing so involves solving two technical problems. The first is to represent a partially full elements of a source model as a functionally equivalent full elements of an effective model with different material properties. The second is to model the boundary conditions of the source model as constraints on the solution values at the nodes of the effective model. Both problems are solved in a way that maintains inner product equivalence, but their procedures are different. If this is done properly, the effective model can represent the important and relevant properties of the source model but in a simpler and easier to compute fashion.

For example, each partially full square of the source model becomes a full square of the effective model for a two-dimensional object. Or, each partially full cube of the source model becomes a full cube of the effective model for a three-dimensional object. In the examples herein, a three-dimensional object is assumed, but these operations could be applied to objects of other dimensions.

1. Determining Effective Model Material Properties

The first technical problem can be expressed as follows. Given a user-provided definition of the geometry and material of an object, find a mesh representation of a different (e.g., simpler) geometry and material such that the inner products are equivalent. The different geometry may be a pre-defined shape over which an FEA solver is programmed to efficiently calculate relevant values.

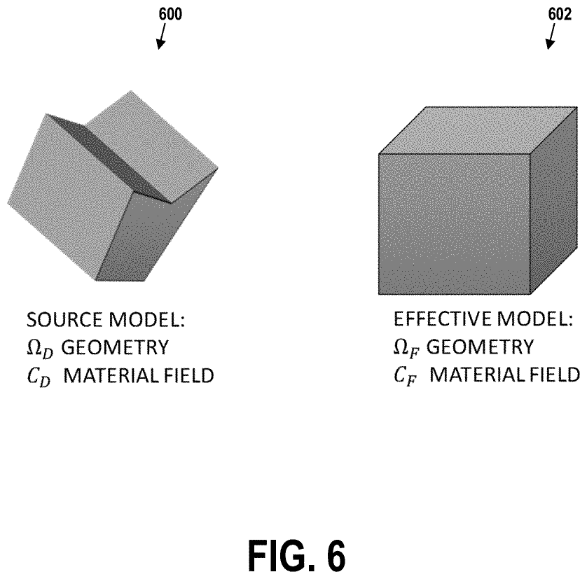

FIG. 6 depicts an arbitrary source model 600 with geometry Ω_{D} and material field (tensor) C_{D}, as well as effective model 602 with geometry Ω_{F} and material field C_{F}. The geometry Ω_{F} may be selected to be of a shape that an FEA solver supports and for which properties can be easily calculated (or at least calculated more easily than for geometry Ω_{D}). Such a shape could be an assembly of cubes, for instance.

The inner product matrix for source model 600 is given as:

a_{D}(u,v)∫_{Ω}_{_{D}}ƒ(u)·C_{D}ƒ(v)d_{Ω}_{_{D}} (23)

Likewise, the inner product matrix for effective model 602 is given as:

a_{F}(u,v)=∫_{Ω}_{_{F}}ƒ(u)·C_{F}ƒ(v)dΩ_{F} (24)

The values u, v∈B={bᵢ} for some basis functions. These inner product matrices are representative of structural stiffness, structural mass, thermal conductivity, thermal expansion, thermal capacitance, and other properties. Specific inner product matrices may be used when their associated properties are considered.

For example, a structural stiffness matrix is given by:

a(u,v)=∫_{Ω}ƒ(u)·Cƒ(v)dΩ (25)

Where u, v are the displacement field trial and test functions, respectively, and ƒ is the strain operator. A structural mass matrix is given by:

a(u,v)=∫_{Ω}u·ρvdΩ (26)

Where u, v are the displacement field trial and test functions, respectively, and p is the material density property. A thermal conductivity matrix is given by:

a(u,v)=∫_{Ω}ƒ(u)·κƒ(v)dΩ, (27)

Where u, v is the temperature field trial and test functions, respectively, K is the material thermal conductivity property matrix, and ƒ is the gradient operator. Other examples are possible.

In any event, given Ω_{D}, Ω_{F}, ƒ, a, and C_{D} from Equations 23 and 24, the goal is to find material field C_{F} and a basis function set B={bᵢ} such that:

a_{D}(u,v)=a_{F}(u,v):∀u,v∈B (28)

In other words, given (i) a source quadrature, shape, and material field, and (ii) an effective quadrature and shape, determine an effective material field.

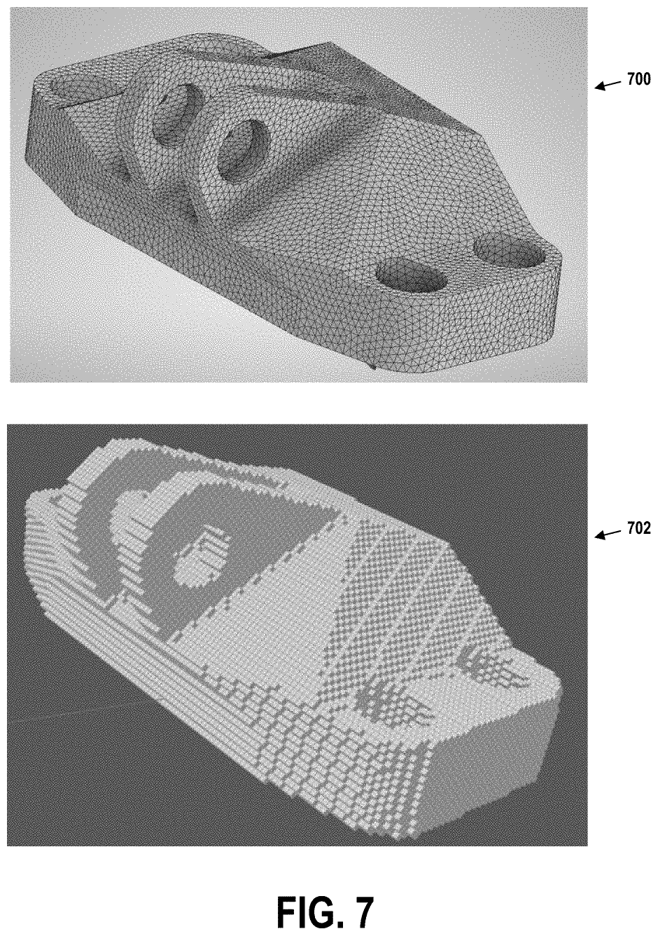

A visual example of this process is provided in FIG. 7. The geometry of a source model is represented as the three-dimensional solid of image 700 (which is the same as the three-dimensional solid of image 300, though the meshing and nodes can be ignored). The geometry of a corresponding effective model is represented as the three-dimensional solid of image 702. Notable, the solid of image 702 is an assemblage of cubes, resulting in a coarser shape. Thus, in order to make these two solids equivalent in terms of their inner product behavior, material properties different from that of the solid of image 700 may be selected for each cube in solid of image 702.

Notably, the selection of material properties can be made per cube, and thus some cubes of the solid of image 702 might have the same material properties as a corresponding location in the solid of image 700, and others might not. Further, some cubes of the solid of image 702 might have different material properties as other cubes in the solid of image 702.

Cubes are used herein as an example type of element shape for the effective model. But other element shapes, such as rectangular prisms or triangles can be used. In some cases, the element shape for the effective model can be selected from a menu of shapes supported by the FEA solver. In various embodiments, different shapes may be used for different elements of the effective model.

With respect to the moment representations of geometry described above, Ω_{D} is defined by moments M_{D}={m_{D,i}} and Ω_{F} is defined by moments M_{F}={m_{F,i}}. Thus, integrals of Equations 23 and 24 may be computed over a domain represented by these moments. This means that the calculations come down to determining how to compute the material field of the effective model, C_{F}, using moments. Doing so may involve the following steps, which may be performed in the given order, or another order where possible.

A first step may involve computing a_{D,ij}=a_{D}(uᵢ,vⱼ) for all possible combinations of i and j (the basis function set B indices). Notably, a_{D,ij} can be calculated from the moments as a_{D,ij}=BᵢⱼₘMₘ, where M is the moment vector. This step is equivalent to computing all elements of a stiffness matrix, for example, as a_{D,ij} is equivalent to element (i,j) of the stiffness matrix.

A second step may involve computing a_{F,ij}=a_{F}(uᵢ,vᵢ) for all possible combinations of i and j. The value of a_{F,ij} is initially unknown but can be expressed as a_{F,ij}=GᵢⱼₙCₙ, where n is the number of material properties in the effective model. Note that Gᵢⱼₙ are known and Cₙ are the unknown material properties.

A third step may involve writing the equations from the first and second steps in the form GC=A. This form is equivalent to GᵢⱼₙCₙ=a_{D,ij}. Specifically, matrix G represents coefficients as a function of quadrature and shape of the effective model, matrix C represents an unknown material properties vector, and matrix A represents stiffness (or other properties) as a function of quadrature, shape, and material of the source model.

A fourth step may involve identifying the rank of the matrix G. If this rank is less than n (i.e., the number of equations is at least equivalent to the number of unknowns) and A∈Col{G}, then there exists a unique solution to GC=A, e.g., a QR decomposition. Note that Col{G} is the column space of matrix G which is defined by the set of all linear combinations of the columns of matrix G. Assuming that there is a solution to GC=A, the values of matrix C can be determined using matrix algebra.

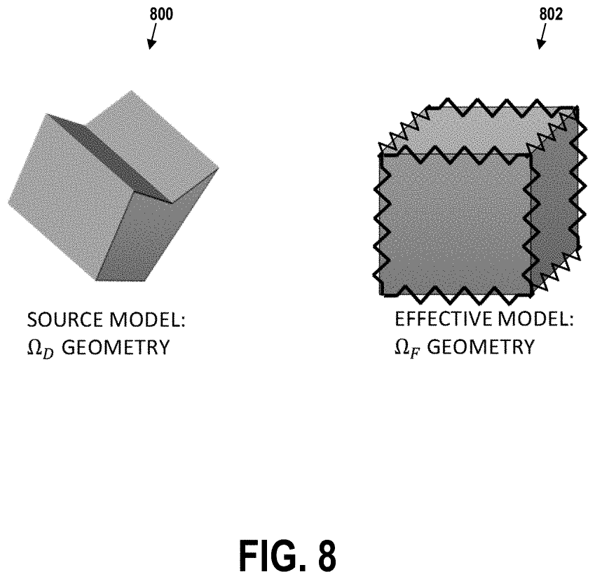

FIG. 8 provides an example of this process using hexahedral elements (polyhedrons with 6 faces). The source model 800 has geometry Ω_{D} and the effective model 802 has geometry Ω_{F}. The source stiffness matrix a_{D,ij}=BᵢⱼₘMₘ is calculated and stored in vector A. The effective stiffness matrix a_{F,ij}=GᵢⱼₙCₙ is calculated and using material constants. These constants include 21 anisotropic material properties (independent elastic constants for a general-purpose material) and 276 “fictitious springs” between all degrees of freedom in each element of geometry Ω_{F}.

Here, a fictitious spring is a mathematical representation of a spring that is not constrained by the laws of physics. For example, a typical spring offers more resistive force as it is pulled apart. A fictitious spring may have “negative” resistive properties, such as pulling itself apart even further as it is pulled. Even though each individual spring might be fictional, their properties can be selected such that they preserve inner product properties in aggregate.

The value of 276 for the number of springs is derived from each hexahedral element having 8 corners that can each move in 3 dimensions for a total of 24 degrees of freedom. The fictitious springs connect all combinations of these degrees of freedom for a total of (24×23)/2=276 springs.

In any event, the equation for the third step above is GᵢⱼₙCₙ=BᵢⱼₘMₘ, where matrix G has a rank of 276 and matrix C represents 21+276 material properties. Each material property can be specified in a file as a constant (e.g., anisotropic constant or a spring constant). The material properties can also be specified using a procedural interface to FEA solver. Thus, matrix C is the sought-after material field C_{F}, and the effective model geometry Ω_{F} and material field C_{F} can be provided to the FEA solver.

Nonetheless, in some cases, a unique solution to GC=A might not exist. For example, certain material properties other than springs may be used for matrix C, and this could result in the rank being equivalent to or exceeding n. This might be necessary if the FEA solver does not accept spring constants as parameters. In these scenarios, a least-squares approach can be taken to approximate a solution.

Particularly, the goal is to find values of C such that the L² norm (e.g., Euclidean distance) of GC=A is minimized. To do this, material property values C can be computed by solving the following equation:

C_{LS}=(G^{T}G)⁻¹G^{T}A (29)

For instance, C can be a vector of 21 anisotropic material properties (independent elastic constants for a general-purpose material). Equation (29) can be solved using standard matrix algebra algorithms, for example, using the QR decomposition.

Alternatively, when a unique solution to GC=A does not exist because the number of material properties is not sufficient, a solution may be found from a reduced basis. Recall from Equation (28) that a_{D}(u,v)=a_{F}(u, v): ∀u, v∈B={bᵢ}. The full set of basis functions is given by:

$${b}_{i} = [ \begin{matrix}\sum {u}_{i , j} {N}_{j} \\ \sum {v}_{i , j} {N}_{j} \\ \sum {w}_{i , j} {N}_{j}\end{matrix} ] \qquad ( 30 )$$

Where Nⱼ are standard shape functions provided by the FEA software that correspond to the element. The goal is to find a reduced basis by selecting only a subset B_{red}⊂B. For example, when options for the target material properties are only anisotropic material properties (21 constants), then exactly 6 basis functions will suffice.

To clarify, the FEA solver can use a vector of shape functions N==1 to number of nodes in the element. The basis function set B={bᵢ} is defined using the shape functions as shown in Equation (30). Typically, the total number of basis functions is an element is the same as the total number of to degrees of freedom. A reduced basis B_{red}⊂B is a subset of the complete basis. Let the cardinality (the number of entities in a set) of B_{red} be n_{red}. The total number of unique values of A is equal to the number of unique values of the inner product a(u, v) where u, v∈B_{red}, which is given by

$${n}_{unique} = \frac{{n}_{r e d} ( {n}_{r e d} + 1 )}{2} .$$

The system of equations GC=A has a valid solution if the number of the material properties C is the same as the number of unique entities of A. Therefore, if the options for the target material properties C are only anisotropic material properties (21 constants), then the required number of basis functions are n_{red}=6, so that the number of unique entities of A are

$${n}_{u n i q u e} = \frac{6 ( 6 + 1 )}{2} = 21 .$$

An example of a reduced basis is the set corresponding to volume fraction based homogenization, given by B_{red}={x, y, z, x+y, x+z, y+z}, which correspond to extension in x, extension in y, extension in z, shear in x−y, shear in x−|z, and shear in y−z.

To verify that effective model geometry Ω_{F} and material field C_{F} produce the same or similar results to that of source model geometry Ω_{D} and material field C_{D}, tests were performed. In one example, the source geometry of image 900 (a cube with a diagonal section cut off) and associated material field was considered. The steps above were carried out to transform this geometry (Ω_{D}) and its associated material field (C_{D}, isotropic with E=1 and v=0.3) into the effective geometry of image 902 (Ω_{F}, which may be a predefined element supported by an FEA solver such as NASTRAN) and its material field (C_{F}, defined by anisotropic and spring constants) with linear elasticity inner products preserved.

To test the accuracy of the transformation, inner product values were calculated for a_{D}(u, u) and a_{F}(u, u) under a random displacement field u. The result, representing energy stored, was the same to four decimal places. Thus, the embodiments herein represent an accurate way of performing structural analysis with less computation required.

2. Determining Boundary Conditions

In FEA procedures, the standard way to impose boundary conditions is via a strong form approach, which assigns prescribed values to degrees of freedom of nodes in a mesh. However, this cannot be done for non-mesh or unfitted mesh source models. Thus, the technical solution to this problem is to impose boundary conditions from the source model onto a predetermined effective geometry that will be given to the FEA solver.

In particular, the strong form is converted, by way of integration, into a weak form that minimizes deviation from a constraint. This is done by formulating the deviation from the constraint using the solution's degrees of freedom of the nodes such that the integral of the deviation over the boundary is minimized. The result is a set of multipoint constraints on mesh nodes of the effective model. These constraints on the nodes may be expressed as linear equations, for example. Notably, the Dirichlet boundary conditions are encoded into an equivalent constraint that is defined only through an integral over the Dirichlet (fixed) boundary.

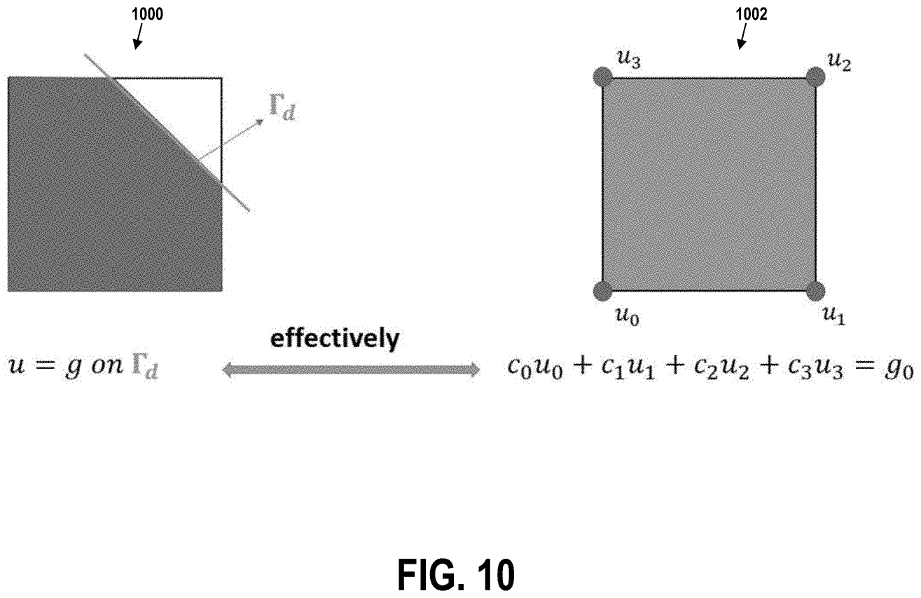

This process is illustrated in FIG. 10. Element 1000 of the source model is a partially-filled square geometry with diagonal constraint Γ_{d}. Element 1002 of the effective model is also a square geometry, but it is filled and meshed with nodes u₁, u₂, u₃, and u₄ at its corners. The strong form can be expressed as:

∫_{Γ}_{_{d}}uwdΓ=∫_{Γ}_{_{d}}gwdΓ (31)

This can be rewritten as:

Σuᵢ∫_{Γ}_{_{d}}NᵢwdΓ=∫_{Γ}_{_{d}}gwdΓ (32)

Where Nᵢ are a set of shape functions. Then, a function w is chosen so that a set of coefficients cᵢ are provided for each node so that Σcᵢuᵢ=g₀. The steps to carry out this procedure are as follows.

First, choose a test function w. Second, compute cᵢ=∫_{Γ}_{_{d}}NᵢwdΓ, where Nᵢ is the ith shape function. Third, compute g₀=∫_{Γ}_{_{d}} gwdΓ. Fourth, assemble the multipoint constraints Σcᵢuᵢ=g₀. Although this solution is described in terms of a two-dimensional problem, analogous procedures could be used to solve three-dimensional problems. Here, N={Nᵢ}, i=1 to number of nodes in the element are the shape functions that are used by the FEA solver.

B. Post-Processing

As noted in FIG. 4, post-processing involves taking a solution (e.g., a field) to an effective model that was provided by an FEA solver and then modifying the values of this solution to a form that applies accurately to the source model. Doing so involves another transformation that preserves inner products.

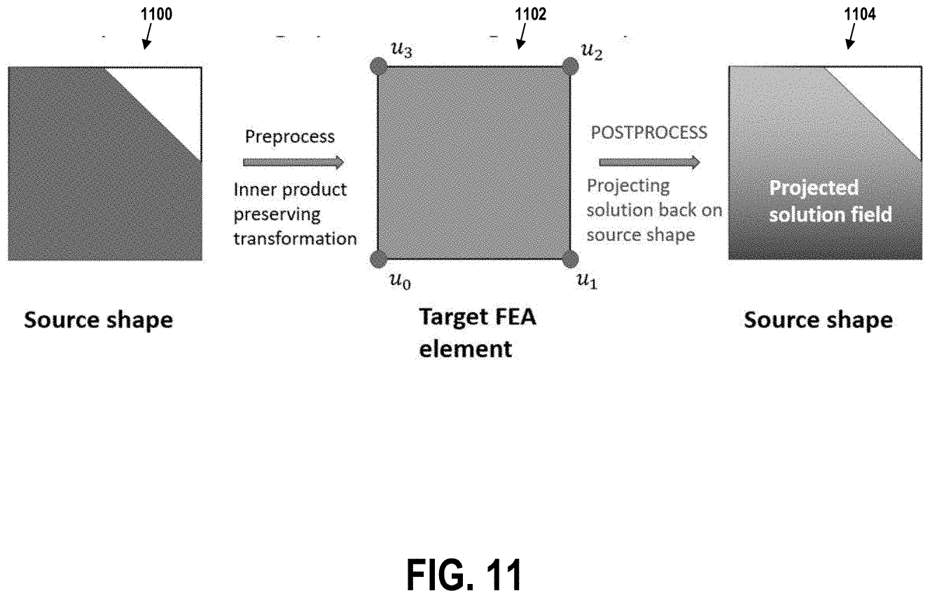

FIG. 11 depicts the post-processing in context of the above procedure for a single element. Source shape 1100 is pre-processed as described above into a target (effective) element 1102 that can be understood and manipulated by an FEA solver. Once the FEA solver has completed its work on element 1102, the resulting solution is projected back onto source shape 1100 to form solution field 1104. Solution field 1104 may be equivalent to or within an acceptable degree of error (e.g., 1%, 2%, 5%) of what the FEA solver would have computed as the solution to a standard meshing of source shape 1100. But as noted above, far less computational power and resources are used.

Particularly, the solution field is projected onto the source shape in accordance with the relationship=ΣuᵢNᵢ, where Nᵢ are the shape functions and uᵢ are the solution coefficients. Then the gradient field g is projected back on the source shape using the inner product preserving transformation:

∫_{Ω}g·wdΩ=∫_{Ω}∇u·wdΩ (33)

The algorithm for performing this projection is given below. It assumes that a solution field u and a shape Ω are given.

Step 0: Consider the x-component of the gradient field first. The y and z components of the gradient will be computed using the same algorithm. The x-gradient in an element is approximated as gₓ≈ΣgⱼNⱼ where Nⱼ are the shape functions used by the FEA solver. The coefficients gⱼ are computed by solving the linear equations A_{g} g=b_{g}, which are the matrix representations of Equation (33), where A_{g} represents the matrix coefficients of the left hand side of Equation (33), b_{g} represents the right hand side of Equation (33) and g represents the unknowns. Set A_{g}=b_{g}=0.

Step 1: For each element Ωₑ, assemble b_{g} by computing the inner product of the gradient of the computed solution and each shape function Nⱼ, using a quadrature rule consisting of points xₖ and weights wₖ:

b_{g}(j)=b_{g}(j)+∫_{Ω}_{ₑ}∇u·NⱼdΩ=Σₖ∇uₓ(xₖ)·Nⱼ(xₖ)·wₖ (34)

Step 2: For each element Ωₑ, assemble A_{g} by interpolating the shape functions Nᵢ and Nⱼ over a quadrature rule consisting of points xᵢ and weights wᵢ:

A_{g}(i,j)=A_{g}(i,j)+∫_{Ω}_{ₑ}Nᵢ·NⱼdΩ=ΣₖNᵢ(xₖ)·Nⱼ(xₖ)·wₖ (35)

Note that the following diagonal matrix approximation for A_{g} can be used for faster solution times:

A_{g}(i,i)=A_{g}(i,i)+∫_{Ω}_{ₑ}NᵢdΩ=ΣₖNᵢ(xₖ)·wₖ (36)

A_{g}(i,j)=0 if i≠j (37)

Step 3: Assemble a linear system A_{g} g=b_{g} consisting of a matrix A_{g} of the elements <Nᵢ,Nⱼ>_{Ω}_{ₑ} for each element and basis index pair (i,j) and a right hand side vector b_{g} consisting of <∇u, Nⱼ>_{Ω}_{ₑ}. This system can then be solved using a variety of techniques such as conjugate gradient, producing solution coefficients gⱼ.

Step 4: The reconstructed gradient in each element can now be found as:

$$\frac{d u}{d x} = \sum {g}_{j} {N}_{j} \qquad ( 38 )$$

Where Nⱼ are the shape functions used by the FEA software. Then steps 1-4 are repeated for y and z components.

### V. Example Operations

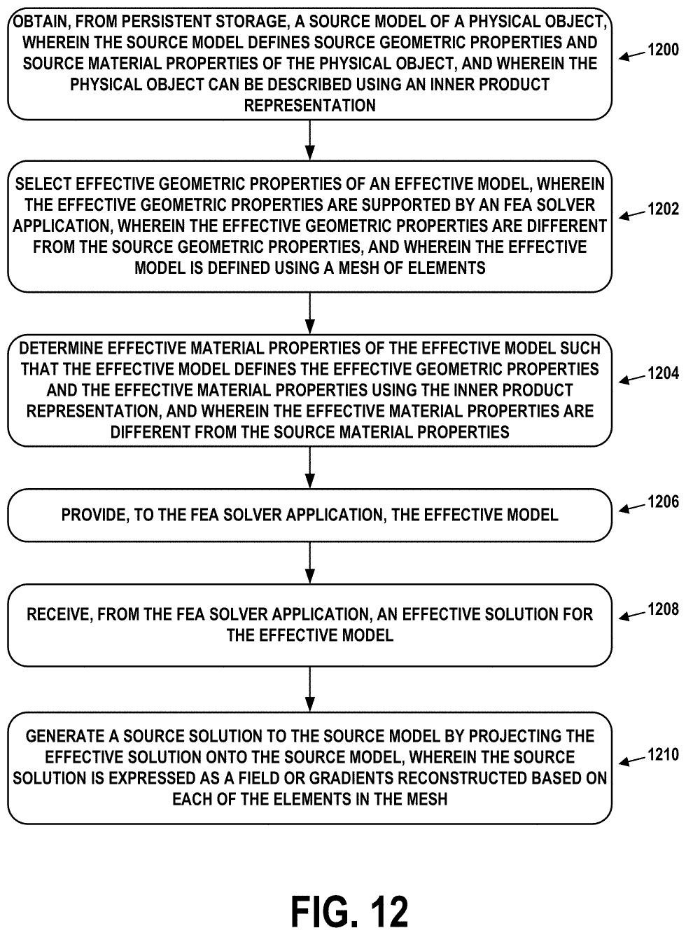

FIG. 12 is a flow chart illustrating an example embodiment. The process illustrated by FIG. 12 may be carried out by a computing device, such as computing device 100, and/or a cluster of computing devices, such as server cluster 200. However, the process can be carried out by other types of devices or device subsystems.

The embodiments of FIG. 12 may be simplified by the removal of any one or more of the features shown therein. Further, these embodiments may be combined with features, aspects, and/or implementations of any of the previous figures or otherwise described herein.

Block 1200 may involve obtaining, possibly from persistent storage, a source model of a physical object, wherein the source model defines source geometric properties and source material properties of the physical object, and wherein the physical object can be described using an inner product representation.

Block 1202 may involve selecting effective geometric properties of an effective model, wherein the effective geometric properties are supported by an FEA solver application, wherein the effective geometric properties are different from the source geometric properties, and wherein the effective model is defined using a mesh of elements.

Block 1204 may involve determining effective material properties of the effective model such that the effective model defines the effective geometric properties and the effective material properties using the inner product representation, and wherein the effective material properties are different from the source material properties. Thus, the effective model may be an equivalent or approximately equivalent finite element model that preserves the inner product representation of the source model.

Block 1206 may involve providing, to the FEA solver application, the effective model.

Block 1208 may involve receiving, from the FEA solver application, an effective solution for the effective model.

Block 1210 may involve generating a source solution to the source model by projecting the effective solution onto the source model, wherein the source solution is expressed as a field or gradients reconstructed based on each of the elements in the mesh. Thus, the source solution may be a field reconstructed based on the elements, gradients reconstructed based on the elements, or both a field and gradients reconstructed based on the elements.

In some embodiments, the effective material properties are determined independently for each of the elements.

In some embodiments, selecting the effective geometric properties comprises selecting the effective geometric properties from a library of geometric properties supported by the FEA solver application.

In some embodiments, the FEA solver application is configured to execute on a computing device not within the system, wherein providing the effective model comprises transmitting a file containing the effective model to the computing device, and wherein receiving the effective solution comprises receiving the effective solution from the computing device.

In some embodiments, the FEA solver application is configured to support a procedural interface through which the effective model can be defined, wherein providing the effective model comprises providing the effective model by way of the procedural interface. The procedural interface may be a Python interface, for example, through which properties of the effective model can be directly assigned.

In some embodiments, determining the effective material properties comprises: computing the inner product representation from basis functions and a moment vector of the source model; and setting the inner product representation as equivalent to a product of (i) a coefficient matrix representing quadrature and shape of the effective model, and (ii) an unknown material properties vector.

In some embodiments, determining the effective material properties further comprises: determining that a rank of the coefficient matrix is less than or equal to a cardinality of the effective material properties; and solving the product for the unknown material properties vector.

In some embodiments, determining the effective material properties further comprises: determining that a rank of the coefficient matrix is greater than a cardinality of the effective material properties; and determining a least squares minimum value for the unknown material properties vector.

In some embodiments, determining the effective material properties further comprises: determining that a rank of the coefficient matrix is greater than a cardinality of the effective material properties; and solving for the unknown material properties vector with a subset of the basis functions.

Some embodiments may involve determining boundary condition properties of the effective model the using inner product representation and boundary integrals. In some embodiments, the elements respectively contain sets of nodes, and wherein determining the boundary condition properties of the effective model further comprises, based on shape functions relating to the physical object, determining multipoint constraints defined in the nodes for each of the elements.

In some embodiments, the elements respectively contain sets of nodes, and wherein generating the source solution comprises, based on shape functions relating to the physical object, determining gradients for each of the nodes in each dimension of the physical object.

In some embodiments, the source material properties include structural stiffness coefficient values, and wherein the source solution comprises structural displacement and stress values based on the structural stiffness coefficient values.

In some embodiments, the source material properties include thermal conductivity coefficient values, and wherein the source solution comprises temperature field and heat flux values based on the thermal conductivity coefficient values.

In some embodiments, the source material properties may relate to a multi-physics model that, for example, represents both thermal and structural properties of the source material. Such a model may be able to capture the structural impact of thermal changes on the source model, for example. In these cases, different inner product representations may be used for each of these properties. Other multi-physics models may include arbitrary combinations of fluid, thermal, structural, electromagnetic, and other physics models.

### VI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage containing a source model of a physical object, wherein the source model defines source geometric properties and source material properties of the physical object, and wherein the physical object can be described using an inner product representation; and
one or more processors configured to:
select effective geometric properties of an effective model, wherein the effective geometric properties are supported by a finite element analysis (FEA) solver application, wherein the effective geometric properties are different from the source geometric properties, and wherein the effective model is defined using a mesh of elements;
determine effective material properties of the effective model such that the effective model defines the effective geometric properties and the effective material properties using the inner product representation, and wherein the effective material properties are different from the source material properties;
provide, to the FEA solver application, the effective model;
receive, from the FEA solver application, an effective solution for the effective model; and
generate a source solution to the source model by projecting the effective solution onto the source model, wherein the source solution is expressed as a field or gradients reconstructed based on each of the elements in the mesh.

2. The system of claim 1, wherein the effective material properties are determined independently for each of the elements.

3. The system of claim 1, wherein selecting the effective geometric properties comprises:
selecting the effective geometric properties from a library of geometric properties supported by the FEA solver application.

4. The system of claim 1, wherein the FEA solver application is configured to execute on a computing device not within the system, wherein providing the effective model comprises transmitting a file containing the effective model to the computing device, and wherein receiving the effective solution comprises receiving the effective solution from the computing device.

5. The system of claim 1, wherein the FEA solver application is configured to support a procedural interface through which the effective model can be defined, wherein providing the effective model comprises providing the effective model by way of the procedural interface.

6. The system of claim 1, wherein determining the effective material properties comprises:
computing the inner product representation from basis functions and a moment vector of the source model; and
setting the inner product representation as equivalent to a product of (i) a coefficient matrix representing quadrature and shape of the effective model, and (ii) an unknown material properties vector.

7. The system of claim 6, wherein determining the effective material properties further comprises:
determining that a rank of the coefficient matrix is less than or equal to a cardinality of the effective material properties; and
solving the product for the unknown material properties vector.

8. The system of claim 6, wherein determining the effective material properties further comprises:
determining that a rank of the coefficient matrix is greater than a cardinality of the effective material properties; and
determining a least squares minimum value for the unknown material properties vector.

9. The system of claim 6, wherein determining the effective material properties further comprises:
determining that a rank of the coefficient matrix is greater than a cardinality of the effective material properties; and
solving for the unknown material properties vector with a subset of the basis functions.

10. The system of claim 1, wherein the one or more processors are further configured to:
determine boundary condition properties of the effective model the using inner product representation and boundary integrals.

11. The system of claim 10, wherein the elements respectively contain sets of nodes, and wherein determining the boundary condition properties of the effective model further comprises:
based on shape functions relating to the physical object, determining multipoint constraints defined in the nodes for each of the elements.

12. The system of claim 1, wherein the elements respectively contain sets of nodes, and wherein generating the source solution comprises:
based on shape functions relating to the physical object, determining gradients for each of the nodes in each dimension of the physical object.

13. The system of claim 1, wherein the source material properties include structural stiffness coefficient values, and wherein the source solution comprises structural displacement and stress values based on the structural stiffness coefficient values.

14. The system of claim 1, wherein the source material properties include thermal conductivity coefficient values, and wherein the source solution comprises temperature field and heat flux values based on the thermal conductivity coefficient values.

15. A computer-implemented method comprising:
obtaining, from persistent storage, a source model of a physical object, wherein the source model defines source geometric properties and source material properties of the physical object, and wherein the physical object can be described using an inner product representation;
selecting effective geometric properties of an effective model, wherein the effective geometric properties are supported by a finite element analysis (FEA) solver application, wherein the effective geometric properties are different from the source geometric properties, and wherein the effective model is defined using a mesh of elements;
determining effective material properties of the effective model such that the effective model defines the effective geometric properties and the effective material properties using the inner product representation, and wherein the effective material properties are different from the source material properties;
providing, to the FEA solver application, the effective model;
receiving, from the FEA solver application, an effective solution for the effective model; and
generating a source solution to the source model by projecting the effective solution onto the source model, wherein the source solution is expressed as a field or gradients reconstructed based on each of the elements in the mesh.

16. The computer-implemented method of claim 15, wherein determining the effective material properties comprises:
computing the inner product representation from basis functions and a moment vector of the source model; and
setting the inner product representation as equivalent to a product of (i) a coefficient matrix representing quadrature and shape of the effective model, and (ii) an unknown material properties vector.

17. The computer-implemented method of claim 16, wherein determining the effective material properties further comprises:
determining that a rank of the coefficient matrix is less than or equal to a total of the effective material properties; and
solving the product for the unknown material properties vector.

18. The computer-implemented method of claim 16, wherein determining the effective material properties further comprises:
determining that a rank of the coefficient matrix is greater than a cardinality of the effective material properties; and
determining a least squares minimum value for the unknown material properties vector.

19. The computer-implemented method of claim 16, wherein determining the effective material properties further comprises:
determining that a rank of the coefficient matrix is greater than a cardinality of the effective material properties; and
solving for the unknown material properties vector with a subset of the basis functions.

20. An article of manufacture including a non-transitory computer-readable medium, having stored thereon program instructions that, upon execution by a computing system, cause the computing system to perform operations comprising:
obtaining, from persistent storage, a source model of a physical object, wherein the source model defines source geometric properties and source material properties of the physical object, and wherein the physical object can be described using an inner product representation;
selecting effective geometric properties of an effective model, wherein the effective geometric properties are supported by a finite element analysis (FEA) solver application, wherein the effective geometric properties are different from the source geometric properties, and wherein the effective model is defined using a mesh of elements;
determining effective material properties of the effective model such that the effective model defines the effective geometric properties and the effective material properties using the inner product representation, and wherein the effective material properties are different from the source material properties;
providing, to the FEA solver application, the effective model;
receiving, from the FEA solver application, an effective solution for the effective model; and
generating a source solution to the source model by projecting the effective solution onto the source model, wherein the source solution is expressed as a field or gradients reconstructed based on each of the elements in the mesh.
